(19) United States
(12) Patent Application Publication
(10) Pub. No.: US 2003/0160506 A1
(43) Pub. Date: Aug. 28, 2003

(54) Wheel for a tracked vehicle

(76) Inventors: Theodor Averkamp, Dusseldorf (DE); Klaus Spies, Remscheid (DE); Volker Hutz, Solingen (DE)

Correspondence Address: Leopold Presser, Scully Scott Murphy & Presser, 400 Garden City Plaza, Garden City, NY, 11530, US

(21) Appl. No.: 10/257,804

(22) PCT Filed: Apr. 12, 2001
(86) PCT No.: PCT/EP01/04258

(30) Foreign Application Priority Data
Apr. 13, 2000 (DE) 10018272.0
Mar. 20, 2001 (DE) 101133632.6

(51) Int. Cl. B62D 55/14

(52) U.S. Cl. 305/136

(57) ABSTRACT

Described is a wheel (10) for a track-laying vehicle, which is provided on a vehicle wheel hub (12). To provide a wheel of that kind, which is of low weight, having optimum damping properties and a slight heat signature, the wheel (10) has a wheel ring (14) of a plastic material.

The invention concerns a wheel as set forth in the classifying portion of claim 1 for a track-laying vehicle. Such a wheel is for example a runner wheel, a support wheel, a support ring or a direction-changing roller for a track of the track-laying vehicle.

A runner wheel of aluminium or fibre-reinforced resin for light track-laying vehicles is known from EP 0 159 934 A2. The runner wheel comprises two circular discs with rings formed thereon. The rings carry rubber tyres on the outside. The discs form a guide channel for centering guide teeth of track members of a track of the track-laying vehicle. All cross-sections of the runner wheel, in particular in the shoulder region, namely in the junction region of the vertical disc with the peripheral ring, are of a comparatively thin cross-section. When travelling on inclined slopes, or when passing over obstacles such as lumps of rock the shoulder region is subjected to a particular loading by virtue of the relatively long lever of the projecting ring. Those alternating stresses have only a very slight influence on the service life of a runner wheel consisting of aluminium. A runner wheel comprising fibre-reinforced resin however is in danger of fracture in that shoulder region. The alternate deformation of the highly loaded shoulder region, with a heating effect, gives rise to micro-brittle fractures so that the fibre plastic matrix breaks down and ruptures. Such a wheel therefore does not attain a long service life.

Taking EP 0 159 934 A2 as the basic starting point the object of the present invention is to provide a wheel of the kind set forth in the opening part of this specification, which has a long service life while being low in weight.

According to the invention that object is attained by the features of claim 1. Preferred configurations of the wheel according to the invention are characterised in the appendant claims.

The wheel according to the invention has the advantage that considerable reductions in weight are possible in comparison with track-laying vehicle wheels of metal. Besides that reduction in weight, there is the advantage that the inherent damping action of the material in conjunction with the reduced weight means that the transmission of vibration as occurs for example due to the wheel rolling over the track and the track gap which is involved in that respect, to the body or shell of the track-laying vehicle, is reduced. In addition the configuration according to the invention affords the advantage of a comparatively slight heat signature so that it is made more difficult for the wheels and therewith the track-laying vehicle to be detected by heat imaging equipment. Further advantages involve the reduction in the unsprung masses of the track-laying vehicle having wheels according to the invention, making handling easier due to correspondingly reduced component weights, a reduction in stockage and transportation weights and resistance to corrosion.

Polyamide is the appropriate plastic material for the wheel. Polyamide basically enjoys a substantially higher level of strength and impact resistance and is more heat-resistant, in comparison with the known material for runner wheels, namely fibre-reinforced resin.

Polyamide has a tensile modulus of elasticity >2000 N/mm² and can be used at between −40° C. and +120° C. Its notched-bar impact strength in that temperature range is at least 10 kJ/m². Moisture absorption is <10% in a standard climate 23/50.

In the case of cast polyamide PA12G the tearing elongation >20% at a tearing speed of 5 mm/min.

Partially aromatised polyamide with a 20-50% glass fibre component has a tearing elongation >2% at a tearing speed of 50 mm/min.

Further details, features and advantages will be apparent from the description hereinafter of embodiments of the wheel according to the invention, which are shown in the drawing in which:

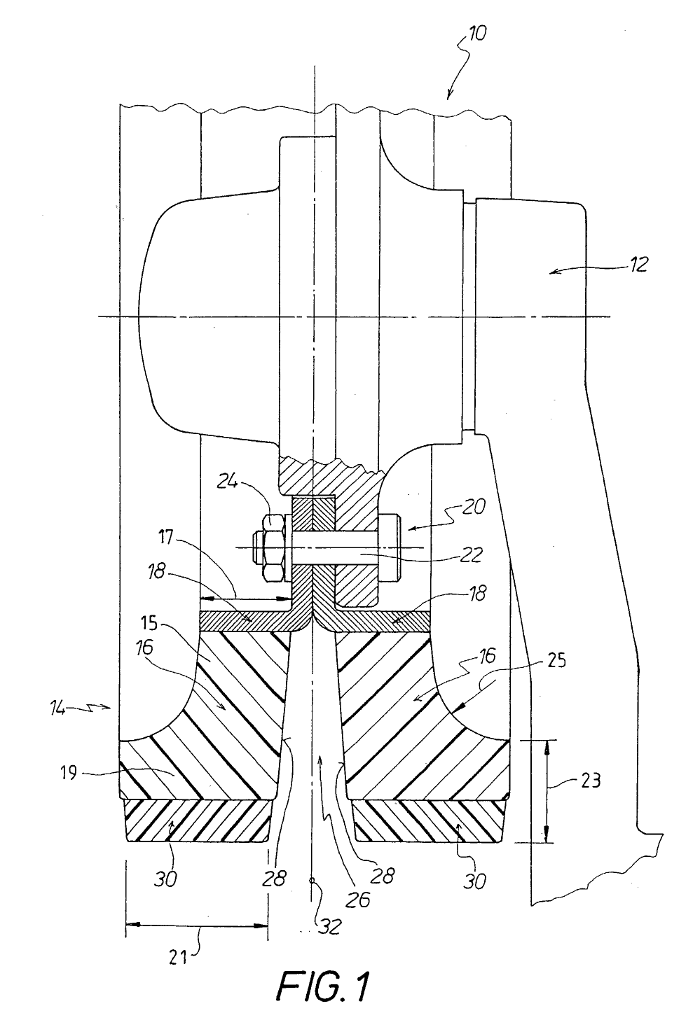

FIG. 1 is a sectional view of a portion of a first embodiment of the wheel for a track-laying vehicle in combination with a portion of a vehicle wheel hub of the track-laying vehicle,

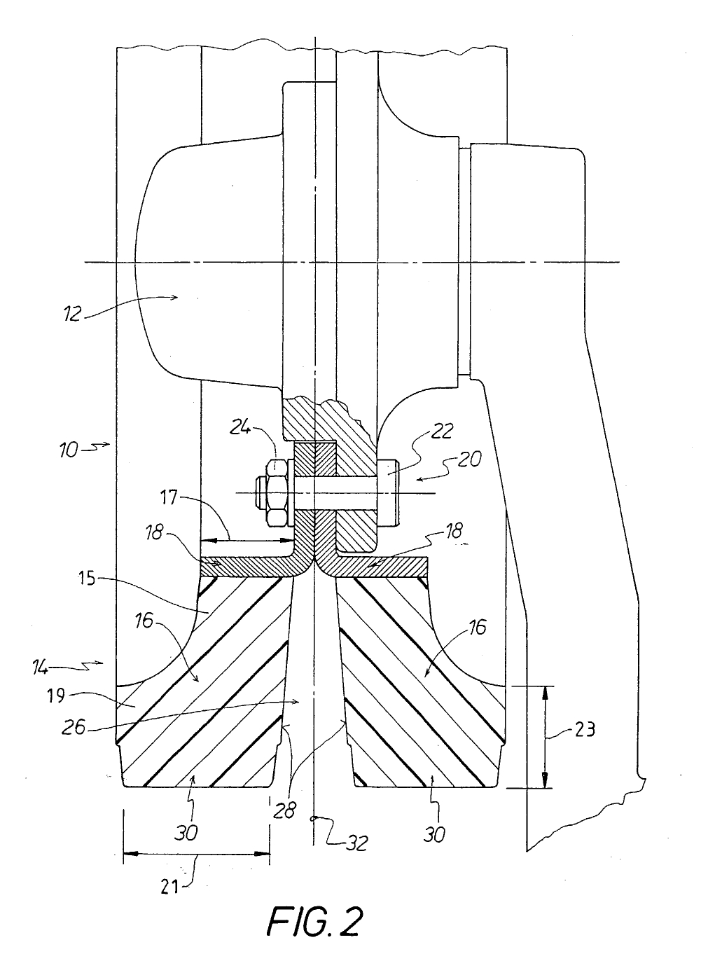

FIG. 2 is a view similar to FIG. 1 of a second embodiment of the wheel for a track-laying vehicle,

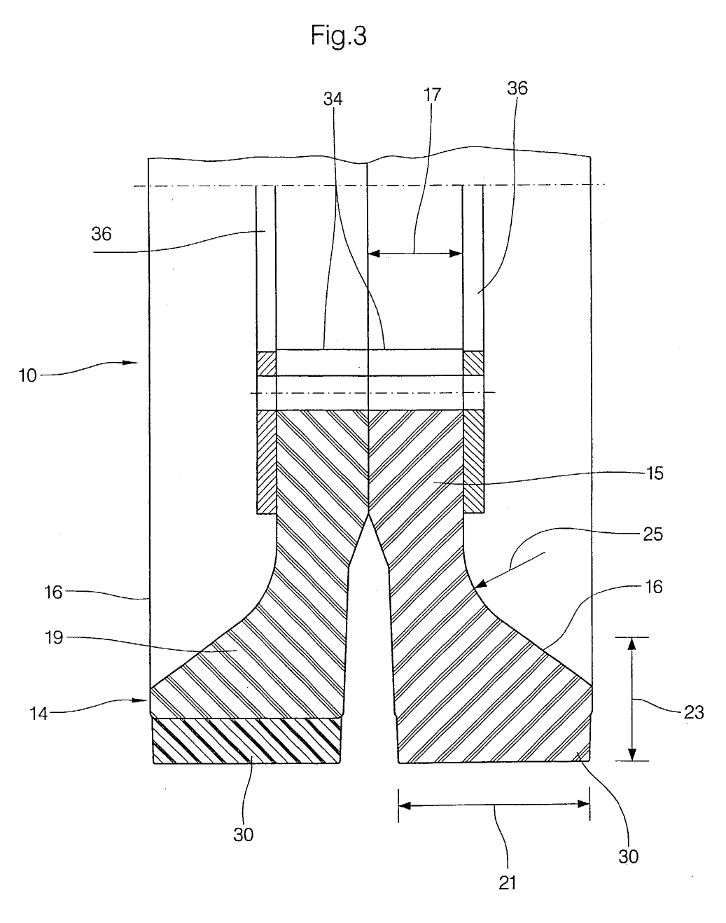

FIG. 3 shows a third embodiment of the track-laying vehicle wheel,

FIG. 4 shows a front view of a wheel for a track-laying vehicle,

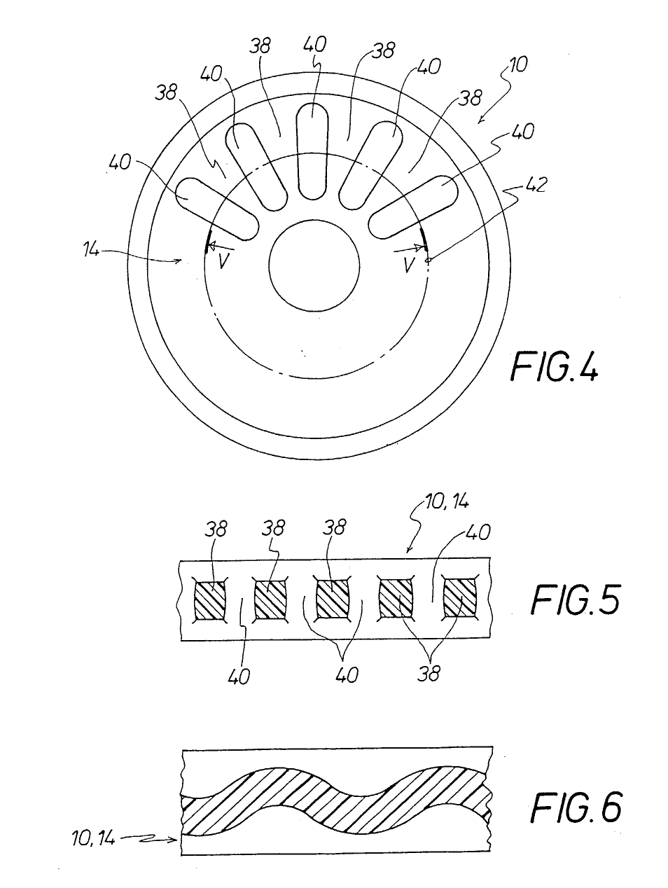

FIG. 5 shows a view in section taken along section line V-V in FIG. 4 through the track-laying vehicle wheel,

FIG. 6 shows a sectional view which is similar in principle to FIG. 5 of another embodiment of the wheel for a track-laying vehicle,

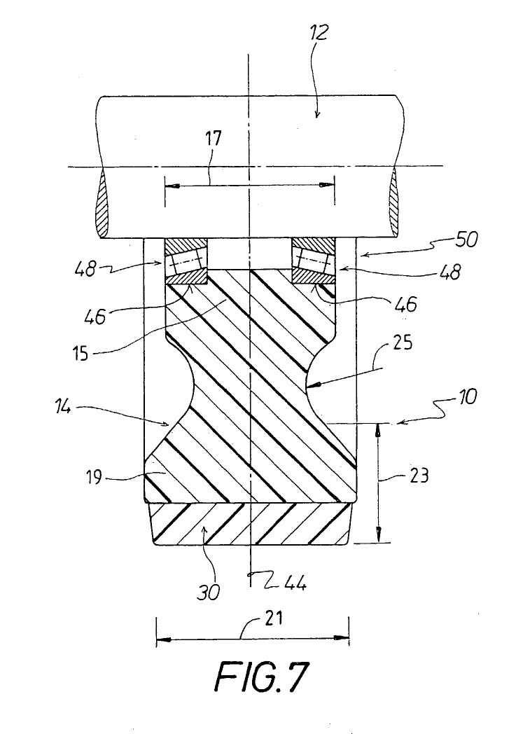

FIG. 7 shows an embodiment of a wheel with integral hub portion for wheel mounting purposes,

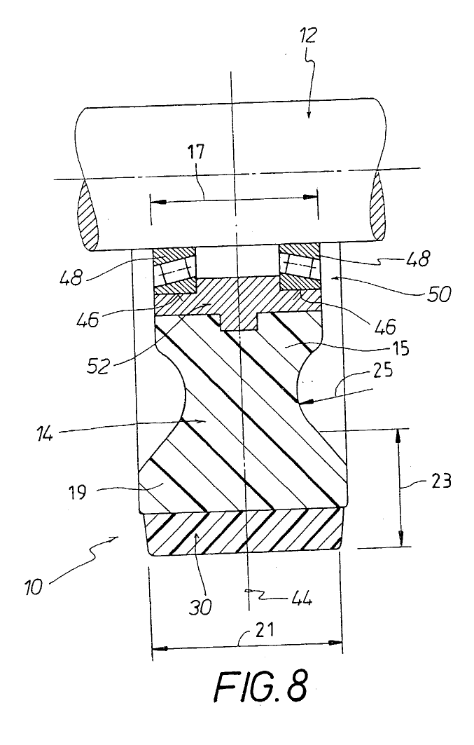

FIG. 8 shows a view similar to FIG. 7 of a wheel with a hub portion connected thereto for wheel mounting purposes,

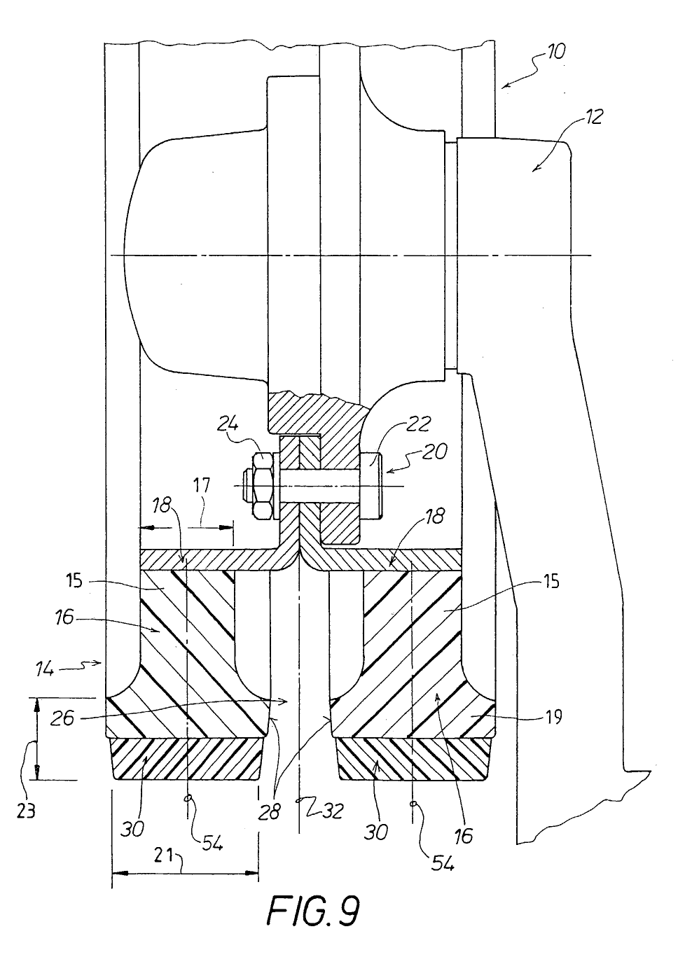

FIG. 9 shows a view similar to FIGS. 1 to 3 of yet another embodiment of the wheel for a track-laying vehicle,

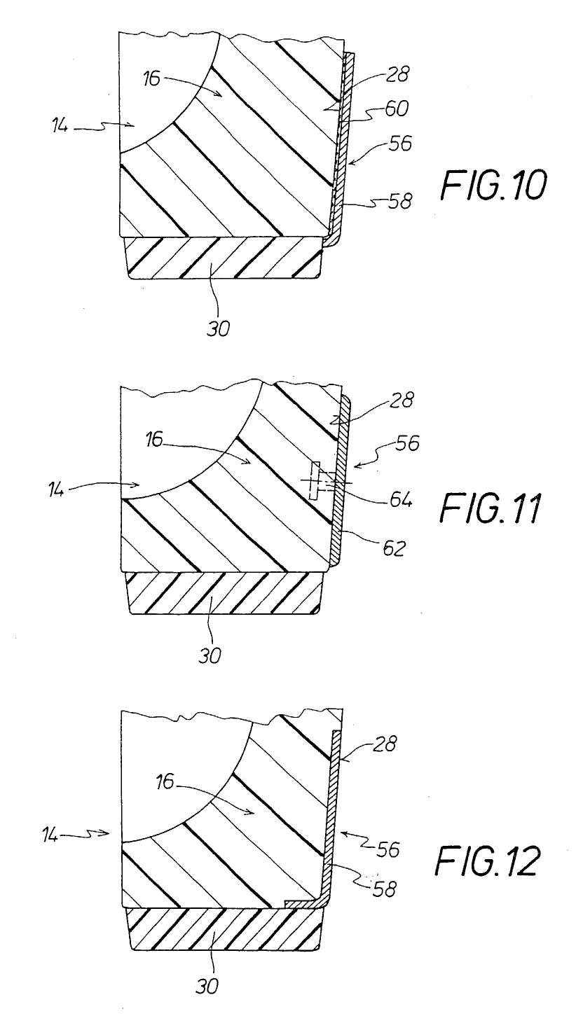

FIG. 10 shows a sectional view of part of an embodiment of the track-laying wheel similar to the embodiments shown in FIGS. 1 to 3, with the incorporation of wear protection,

FIG. 11 shows a view similar to FIG. 10 of another embodiment of the wear protection, and

FIG. 12 shows yet another embodiment of the wear protection of a wheel, indicated similarly to FIGS. 10 and 11.

FIG. 1 is a sectional view of a portion of a wheel 10 for a track laying vehicle. The wheel 10 is provided on a wheel hub 12 of which a portion is illustrated. The wheel 10 has a wheel ring 14 comprising two ring portions 16. The wheel ring 14, that is to say the two ring portions 16 of the wheel ring 14, comprise a plastic material. That plastic material is PA. In order to achieve a high level of mechanical strength and resistance to heat, the two ring portions 16 of the wheel ring 14 can be fibre-reinforced.

Each ring portion 16 is divided into a disc 15 of a width 17 and a ring 19 formed in one piece thereon, of a width 21 and a thickness 23. A radius is identified by 25.

Each of the two ring portions 16 is fixedly connected to an associated flange ring 18. This connection can be a connection involving positively locking engagement and/or force-locking engagement and/or intimate joining of the materials involved. The two flange rings 18 are of an L-shaped cross-sectional profile and are fixedly connected to each other and to the vehicle wheel hub 12 by means of connecting elements 20 formed by screws 22 and nuts 24.

The flange rings 18 comprise for example steel or a light metal or light metal alloy.

The two ring portions 16 of the wheel ring 14 of the wheel 10 are provided in such a way that a peripherally extending guide channel 26 is formed between them. The guide channel 26 is delimited by mutually facing guide surfaces 28 of the ring portions 16. The guide surfaces 28 of the ring portions 16 of the wheel ring 14 of the wheel 10 serve to guide the wheel 10 on the guide tooth of the respective track member of the track-laying vehicle.

Provided at the outside periphery of the ring portions 16 of the wheel ring 14 is a respective chemically bound runner ring 30. The runner rings 30 comprise for example a rubber or a plastic material or another suitable elastomer material. The runner rings 30 roll over the inside running surface of the corresponding track member.

In the embodiment illustrated in FIG. 1 the ring portions 16 and the runner rings 30 provided at the outside periphery thereof are of a cross-section of mirror image symmetry, in relation to the guide channel 26. The plane of symmetry is indicated by the dash-dotted line 32.

FIG. 2 is a view similar to FIG. 1 showing an embodiment of the wheel 10 which differs from the embodiment illustrated in FIG. 1 in that the runner rings 30 are integral components of the respective ring portion 16 and the ring 19 of the wheel ring 14 of plastic material.

The same details are denoted in FIG. 2 by the same references as in FIG. 1 so that there is no need for all those details to be described once again, in connection with FIG. 2.

FIG. 3 is a diagrammatic view similar to FIGS. 1 and 2 showing an embodiment of the wheel 10 with a wheel ring 14 comprising two ring portions 16 of plastic material, wherein each of the two ring portions 16 is formed in one piece with the associated flange ring 34. Provided at the outside periphery of one of the two ring portions 16 of plastic material is a runner ring 30, in a similar manner to the embodiment of FIG. 1. The ring portion 16 shown at the right represents a variant of the ring portion 16 shown at the left insofar as—corresponding to FIG. 2—the runner ring 30 is an integral component of the wheel ring 14 or the ring 19 respectively.

The flange rings 34 which are integrally connected to the ring portions 16 can be fixed jointly to the vehicle wheel hub 12 by means of supporting ring members 36. The supporting ring members 36 are for example a steel ring with bores for connecting elements 20 which have screws 22 and nuts 24, see FIG. 2.

The same details are denoted in FIG. 3 by the same references as in FIGS. 1 and 2 so that there is no need for all those features to be described in detail once again in conjunction with FIG. 3.

FIG. 4 is a diagrammatic front view on reduced scale of a wheel 10, wherein the wheel ring 14 has spoke-like arms 38, of which only some are illustrated in the drawing. The spoke-like arms 38 alternate with openings 40 in the wheel ring 14, of which also only a few are shown in the drawing. The openings 40 and the arms 38 are uniformly distributed along a pitch circle 42 of the wheel ring 14, as can also be seen in respect of a portion thereof from FIG. 5. Such a configuration results in a reduction in the weight of the wheel 10. To increase the stiffness in respect of shape of the wheel 10 or its wheel ring 14 of plastic material, it is for example also possible for the wheel ring 14 to be designed with a corrugated profile in the peripheral direction, as is shown in section in respect of a portion thereof in FIG. 6.

FIG. 7 is a diagrammatic view in section of a portion of a vehicle wheel hub 12 with a wheel 10. The wheel 10 has a single wheel ring 14 of a plastic material. The wheel ring 14 is of a symmetrical cross-sectional profile. That is indicated by the dash-dotted line of symmetry 44. Provided at the outside periphery of the wheel ring 14, facing towards the vehicle wheel hub 12, are peripherally extending channels 46 which are concentric with respect to the vehicle wheel hub 12 and which serve to receive bearing elements 48. Those bearing elements 48 are for example rolling bearings which form a wheel mounting arrangement 50.

FIG. 8 is a diagrammatic view similar to FIG. 7 showing a wheel 10 which differs from the embodiment illustrated in FIG. 7, in particular insofar as the wheel ring 14 of symmetrical cross-section profile has a hub element 52 which is provided for receiving bearing elements 48 in the form of rolling bearings which form the wheel mounting arrangement 50. The annular hub portion 52 is connected to the wheel ring 14. This connection may be a connection involving positively locking engagement and/or force-locking engagement and/or intimate joining of the materials involved. The hub portion 52 comprises a metal or a metal alloy.

The same details are denoted in FIG. 8 by the same references as in FIG. 7 so that there is no need for all those features to be described in detail once again in conjunction with FIG. 8.

FIG. 9 is a view similar to FIGS. 1 and 2 respectively, showing an embodiment of the wheel 10, wherein the wheel ring 14 has two ring portions 16 which are each of a symmetrical cross-sectional profile. The corresponding line of symmetry is indicated by the associated dash-dotted line 54. In other respects the embodiment of FIG. 9 is similar to the embodiment shown in FIG. 1, wherein the same features are denoted in FIGS. 1 and 9 by the same respective references, without being described in detail once again with reference to FIG. 9. The symmetrical configuration however is not absolutely necessary.

FIG. 10 is a cross-sectional view showing a part of a ring portion 16, similarly to FIGS. 1 and 3, wherein the corresponding guide surface 28 of the respective ring portion 16 is provided with wear protection 56. In the embodiment illustrated in FIG. 10 the wear protection 56 is formed by a wearing ring 58 which is fixed to the associated guide surface 28. That fixing is effected for example by means of an adhesive 60. Another possibility for example provides that the wearing ring 58 is vulcanised to the ring portion 16. Instead of the wearing ring 58, it is also possible to use ring segments 62 (FIG. 11).

FIG. 11 is a view similar to FIG. 10 showing a part of a ring portion 16 with a wear protection 56 at the associated guide surface 28, being formed by ring segments 62. Each ring segment 62 has at least one fixing projection 64. The fixing projections 64 of the ring segments 62 are cast into the associated ring portion 16 of plastic material. In comparison with a wearing ring 58 (see FIG. 10), ring segments 62 have the advantage that they are capable of compensating for differences in thermal expansion, caused by the material involved, as between the material of the respective ring portion 16 and the associated wear protection 56. The ring segments 62 can be replaceably mounted to the ring portion 11.

FIG. 12 is a diagrammatic view similar to FIGS. 10 and 11 showing a ring portion 16 with a wear protection 56 on the associated guide surface 28. The wear protection 56 is formed by a wearing ring 58 which is cast into the associated ring portion 16. The wear protection 56 can also be formed by separate ring segments 62, as have been mentioned hereinbefore with reference to FIG. 11.

As in the embodiments of FIGS. 1, 3 and 9, the ring portion 16 is provided at its outer periphery with a respective runner ring 30.

A summary of the dimensional relationships of the disc 15 and the ring 19 is produced on the basis of the width 17 of the disc 15=100%.

| FIGS. | 1 | 2 | 3 | 7 | 8 | 9 |
|---|---|---|---|---|---|---|
| Width 17 of the | 22 | 22 | 22 | 40 | 40 | 23 |
| disc 15 = 100% | | | | | | |
| [mm] | | | | | | |
| Width 21 of the | 40 | 35 | 43 | 50 | 50 | 39 |
| ring 19 [mm] | | | | | | |
| Width 21 in % | 181 | 159 | 195 | 125 | 125 | 169 |
| of width 17 | | | | | | |
| Thickness 23 | 24 | 24 | 30 | 28 | 28 | 20 |
| of the ring | | | | | | |
| 19 [mm] | | | | | | |
| Ratio thickness | 1:1.1 | 1:1.1 | 1:1. | 1:0.7 | 1:0.7 | 1:0. |
| 23/width 17 | | | 36 | | | 87 |
| Thickness 23 in | 110 | 110 | 136 | 70 | 70 | 87 |
| % of width 17 | | | | | | |
| of the disc 15 | | | | | | |
| Ratio thickness | 1:1. | 1:1. | 1:1. | 1:1. | 1:1. | 1:1. |
| 23/width 21 | 67 | 45 | 43 | 78 | 78 | 95 |
| Width 21 in % | 167 | 145 | 143 | 178 | 178 | 195 |
| of thickness 23 | | | | | | |

### LIST OF REFERENCES

10 wheel

12 vehicle wheel hub (for 10)

14 wheel ring (of 10)

15 disc

16 ring portions (of 14)

17 width (of 15)

18 flange ring (for 16), (base ring)

19 ring

20 connecting elements (between 10 and 12)

21 width (of 19)

22 screws (of 20)

23 thickness (of 19)

24 nut (of 20)

25 radius

26 guide channel (of 14)

28 guide surfaces (of 26)

30 runner ring (on 10)

32 dash-dotted line (plane of symmetry)

34 flange ring (of 16), (base ring)

36 support ring (on 34)

38 spoke-like arms (of 10)

40 openings (in 10)

42 pitch circle (for 38, 40)

44 dash-dotted line (plane of symmetry)

46 channels (for 48)

48 bearing elements (for 50), (base ring)

50 wheel mounting arrangement

52 hub element (of 14), (base ring)

54 dash-dotted line (plane of symmetry)

56 wear protection (on 28)

58 wearing ring (of 56)

60 adhesive (for 56)

62 ring segments (of 56)

64 fixing projections (on 62)

1. A wheel (10) for a track-laying vehicle, which is provided at a vehicle wheel hub (12), wherein
the wheel (10) comprises a plastic material, and
the wheel (10) is formed from a wheel ring (14) comprising a vertical disc (15) and a peripheral wider ring (19), wherein a radius (25) is provided between the laterally projecting ring (19) and the disc (15),
characterised in that
the wheel ring (15) comprises polyamide with
a tensile modulus of elasticity >2000 N/mm² and
a tearing elongation >2%, and
the wheel ring (14) is of a solid configuration—viewed in cross-section—in the form of an elephant foot, insofar as the width (21) of the ring (19) is 1.0-2.5 times its thickness (23), its thickness (23) is 0.5-1.5 times the width (17) of the disc (15) and the disc (15) is fixedly connected to a base ring (18, 34, 52) of metal, wherein said base ring (18, 34, 52) is connected to the vehicle wheel hub (12).

2. A wheel according to claim 1 characterised in that the dimensions of the ring (19) in dependence on the width (17=100%) of the disc (15) are:
width (21) of the ring (19) from 110 to 210%.

3. A wheel according to claim 1 characterised in that the polyamide is a cast polyamide PA12G with a tearing elongation >20% at a tearing speed of 5 mm/min or a partially aromatised polyamide with a 20 to 50% glass fibre component with a tearing elongation >20% at a tearing speed of 50 mm/min.

4. A wheel according to claim 1 characterised in that the wheel ring (14) has two ring portions (16), between which is formed a peripherally extending guide channel (26) delimited by mutually facing guide surfaces (28).

5. A wheel according to claim 4 characterised in that the guide surfaces (28) are provided with a wear protection (55, 56).

6. A wheel according to claim 5 characterised in that the wear protection (56) comprises a wear-resistant composite material embedded in the plastic material or metallic or ceramic substances in the form of fibres or whiskers, or a coating on the wearing region with wear-resistant substances.

7. A wheel according to claim 5 characterised in that the wear protection (56) is formed by wearing rings (58) or by ring segments (62) which are fixed to the guide surfaces (28).

8. A wheel according to claim 5 characterised in that the wear protection (56) is formed by coatings on the guide surfaces (28).

9. A wheel according to one of the preceding claims characterised in that a respective runner ring (30) is provided at the outside periphery of the rings (19).

10. A wheel according to claim 9 characterised in that the runner ring (30) is an integral component of the respective ring (19), or
the runner ring (30) comprises an elastomer material and is fixed to the associated ring (19).
